(19) United States
(12) Patent Application Publication
(10) Pub. No.: US 2024/0025527 A1
(43) Pub. Date: Jan. 25, 2024

(54) A PROPULSION SYSTEM FOR VESSEL AND A VESSEL COMPRISING THE PROPULSION SYSTEM

(71) Applicant: SVITZER A/S, Copenhagen K (DK)

(72) Inventors: Thomas BANGSLUND, Holbæk (DK); Esben GRUNDTVIG, Copenhagen S (DK)

(21) Appl. No.: 18/023,653

(22) PCT Filed: Aug. 31, 2021
(86) PCT No.: PCT/EP2021/074045

§ 371 Date: Feb. 27, 2023

(30) Foreign Application Priority Data
Sep. 2, 2020 (DK) PA202070567

(51) Int. Cl. B63H 21/20; B63B 35/68; B63H 23/06; B63H 25/42

(52) U.S. Cl. CPC B63H 21/20; B63B 35/68; B63H 23/06; B63H 25/42; B63H 2023/062

(57) ABSTRACT

Disclosed is a propulsion system for a vessel. The propulsion system comprises a prime mover for generating propulsion power, a first propulsor and a second propulsor for converting the propulsion power to thrust. The prime mover comprises an output shaft for driving the first propulsor and the second propulsor, wherein the first propulsor is drivably connected to a first end of the output shaft of the prime mover and the second propulsor is drivably connected to a second end of the output shaft of the prime mover.

The present disclosure pertains to the field of marine propulsion system. The present disclosure relates to a propulsion system for a vessel and a vessel comprising the propulsion system.

### BACKGROUND

A vessel for towing, such as a tugboat or tug, is a secondary boat that is used for maneuvering other, typically larger, vessels by pushing or pulling them either by direct contact or by means of a tow line. Tugs typically move vessels that either are restricted in their ability to maneuver on their own, such as ships in a crowded harbor or a narrow canal, or vessels that cannot move by themselves, such as barges, disabled ships, log rafts, or oil platforms.

Without the help from a more nimble and maneuverable towing vessel, larger ships, such as mega-ships, would not be able to, or at least have difficulties, getting into a port.

Tugboats may use their propulsion system and/or hydrodynamic characteristics of the hull to generate forces for maneuvering the towed vessel. Tugboats may operate in a direct towing mode or an indirect towing mode. During direct mode operations a towline force on the towing line is produced, due to a pull of the tugboat's propulsion system. Therefore, operations such as stopping or reducing the towed vessel's initial movement, or assisting the towed vessel during steering, is performed by keeping the tugboat either parallel to the vessel's centerline or open to the corresponding side of the towed vessel.

During indirect towing, which may also be referred to as dynamic towing, the tugboat usually trails the towed vessel and exerts forces on the towed vessel for turning and/or decelerating the towed vessel. The tugboat's propulsion system may be used to place and maintain the hull of the tugboat in an angled position in relation to the towed vessel. Thereby, hydrodynamic forces will be created by the vessel's hull acting against the direction of travel of the towed vessel. By positioning the side, such as a starboard or port side, of the tugboat against the direction of travel of the towed vessel the hull of the tugboat will provide a large surface acting against the flow direction of the water thereby generating drag forces which may be transmitted to the towed vessel for turning and/or decelerating the towed vessel. Decelerating and/or steering is controlled by the tug by maintaining a reference angle corresponding to the water flow direction, as opposed to the direction taken by the towed vessel. The port side is the side of the vessel which is to the left of an observer facing the bow, that is, facing forward towards the direction the vessel is heading when underway, and the starboard side is to the right side of such an observer.

Tugboats are typically powered by a plurality of compact high-speed diesel engines driving respective propellers or thrusters. Since such tugboats typically use a plurality of diesel engines operating at high speeds, they are generally overpowered in most situations, and are therefore suboptimal with regards to fuel efficiency.

### SUMMARY

Accordingly, there is a need for a propulsion system and a vessel, which mitigate, alleviate or address the shortcomings existing and provide a propulsion system having an increased fuel efficiency and cost efficiency.

Disclosed is a propulsion system for a vessel. The propulsion system comprises a prime mover for generating propulsion power, a first propulsor and a second propulsor for converting the propulsion power to thrust. The prime mover comprises an output shaft for driving the first propulsor and the second propulsor. The first propulsor is drivably connected to a first end of the output shaft of the prime mover and the second propulsor is drivably connected to a second end of the output shaft of the prime mover.

It is an advantage of the propulsion system of the present disclosure that a single prime mover may be used to drive all of the propulsors of the vessel. By using a single prime mover for driving the first and second propulsor, the number of prime movers used in the propulsion system can be reduced which reduces the size and the cost of the propulsion system. Maintenance costs may also be reduced since maintenance has to be performed on a fewer number of engines. Using a single prime mover further allows a larger prime mover to be used, which may be configured to operate at lower speeds, thereby increasing the efficiency of the propulsion system. Furthermore, larger engines are easier to configure for alternative fuel sources (such as methanol or ammonia), thereby reducing the environmental impact when operating the vessel. The prime mover may e.g. be a low speed two-stroke crosshead diesel engine, having a higher efficiency than high-speed diesel engines typically used.

Disclosed is a vessel comprising the propulsion system according to the current disclosure.

It is an advantage of the vessel of the present disclosure that a single prime mover may be used to drive all of the propulsors of the vessel. By using a single prime mover for driving the first and second propulsor, the number of prime movers used in the propulsion system can be reduced which reduces the size and the cost of the propulsion system. Maintenance costs may also be reduced, since maintenance has to be performed on a fewer number of engines. Using a single prime mover further allows a larger prime mover to be used, which may be configured to operate at lower speeds, thereby increasing the efficiency of the propulsion system. Furthermore, larger engines are easier to configure for alternative fuel sources (such as methanol or ammonia), thereby reducing the environmental impact when operating the vessel. Thereby, the efficiency of the vessel may be improved.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 illustrates a top down view of a known propulsion system,

FIG. 2 illustrates a top down view of some first exemplary propulsion systems according to this disclosure,

FIG. 3 illustrates a top down view of some second exemplary propulsion systems according to this disclosure,

FIG. 4 illustrates a top down view of some third exemplary propulsion systems according to this disclosure, and

FIG. 5 illustrates an exemplary vessel comprising a propulsion system according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

A propulsion system for a vessel is disclosed. The propulsion system comprises a prime mover for generating propulsion power, a first propulsor and a second propulsor for converting the propulsion power to thrust. Thrust herein refers to the propulsive force moving the vessel forward, backwards and/or sideways in a water. The prime mover comprises an output shaft for driving the first propulsor and the second propulsor. The first propulsor is drivably connected to a first end of the output shaft and the second propulsor is drivably connected to a second end of the output shaft, such as a crankshaft of the prime mover. The first end of the output shaft may point in a first direction. The first direction may be parallel to the longitudinal axis of the output shaft. The second end of the output shaft may point in a second direction opposite to the first direction.

The prime mover may be an internal combustion engine. The output shaft may be a crankshaft of the internal combustion engine. In some example propulsion systems, the internal combustion engine is a diesel engine. In some example propulsion system, the prime mover may be a medium speed engine, such as an engine operating with rated speeds in the range of 400 revolutions per minute (rpm) to 1200 rpm. In some example propulsion system, prime mover may be configured to deliver its rated power at 400 rpm or lower, which may also be referred to as a low-speed engine. High-speed engines typically operate with rated speeds of 1200 rpm or above.

In one or more examples, the diesel engine may be a two-stroke diesel engine, such as a two-stroke crosshead diesel engine. The low-speed engine has the benefit that the expansion stroke is slower, thereby providing more time for the combustion process of the fuel. This allows the use of slow burning fuels, such as methanol or ammonia, which would not have sufficient time to burn in medium or high-speed engines. The low-speed engine further has the benefit that the engine operates at speeds which are suitable for driving the propulsor, such as a propeller or thruster. The propulsion system may thus not require a gearbox mounted between the prime mover and the propulsor to propel the vessel.

The crosshead diesel engine allows the engine to be designed with a long stroke, such as a bore to stroke ratio in the range of 1:2-1:4. The crosshead diesel may be configured with longer strokes than other engines, such as trunk type engines commonly used. This allows the engine to burn a greater quantity of fuel per stroke. The fuel used can be of a lower grade than that used in a trunk piston engine. The two-stroke crosshead diesel engine has the benefit that it provides a high efficiency, such as a thermal efficiency higher than 50%. Furthermore, the efficiency of diesel engines, and especially of two-stroke low speed diesel engines, such as the two-stroke crosshead diesel engine, is substantially independent of a load over a wide load range, such as a load range of the engine in the range of 50-100%. Low speed engines, such as low-speed diesel engines, such as the two-stroke crosshead diesel, are particularly suited to digest any fuels with high efficiency and good reliability. Using a low-speed diesel engine, such as the two-stroke crosshead diesel as the prime mover, thus has the benefit that it provides greater fuel flexibility than the traditional choices of prime movers for tugs. The prime mover may thus be fueled with low cost carbon dioxide (CO₂) neutral fuels, that may be difficult to combust in other types of engines, such as in four-stroke internal combustion engines. Examples of CO₂ neutral fuels may be synthetic fuel, such as methane, gasoline, diesel fuel, jet fuel or ammonia, produced from renewable or sustainable energy used to hydrogenate carbon dioxide directly captured from the air, recycled from power plant flue exhaust gas or derived from carbonic acid in seawater.

The first propulsor and/or the second propulsor may in one or more example propulsion systems be propellers. The first propulsor and/or the second propulsor may in one or more example propulsion systems be thrusters, such as azimuth thrusters, and/or Voith Schneider propellers, which are also known as cycloidal drives. Azimuth thruster may be rotated through 360° in a horizontal plane, thereby allowing the thrust to be generated in any desired direction. Thrusters may improve maneuverability of existing vessels, particularly at low speeds, and provide a high level of redundancy. The main propulsion system based on thrusters may also provide increased speed, or lower installed power and reduction in fuel consumption. A further advantage of thrusters is that they produce less vibrations and noise. Since the thrusters are steerable, the thrusters may be used for steering the vessel instead of a traditional rudder. In one or more example propulsion systems, the first propulsor is a propeller and the second propulsor is a thruster. In one or more example propulsion systems, the first propulsor is a thruster and the second propulsor is a propeller.

In one or more example propulsions systems, the thrusters, such as the azimuth thrusters, are controllable pitch thrusters. Controllable pitch thrusters have the benefit that the pitch of the thrusters can be varied to control the hydrodynamic performance of the thruster. Thereby, the fuel consumption and emissions may be reduced.

In one or more examples, the propulsion systems may comprise a control system for controlling the propulsion system. The control system may be configured to control the prime mover and/or the thrusters, such as for controlling the pitch of the controllable pitch thrusters. The control unit may comprise a communication interface for receiving input signals and/or transmitting output signals, a processor and a memory for storing instructions that when executed by the processor causes the control system to control the propulsion system. The communication interface may be a wired or wireless communication interface. The instructions may in one or more examples be an optimization model for optimizing hydrodynamic properties and/or fuel economy of the propulsion system. The control system may receive, for example from an operator of the vessel, a thrust request as input. The control system may use the thrust request as input to the optimization model and may calculate a rotational speed, such as an rpm, of the prime mover, and or a pitch angle of the first and/or the second thruster, which provides the requested thrust while optimizing the fuel consumption and/or the hydrodynamic properties of the propulsion system.

In one or more example propulsion systems, the first propulsor and the second propulsor is a thruster. In one or more example propulsion systems, the first propulsor and the second propulsor is a propeller.

The propulsion system may comprise one or more electric motors. The one or more electric motors may be drivably connected to the first propulsor and/or the second propulsor. The propulsion system may thus be a hybrid propulsion system comprising the prime mover and the one or more electric motors for driving the first and/or second propulsor. The propulsion system may comprise a first electric motor and/or a second electric motor. The first electric motor may be drivably connected to the first propulsor and/or the second electric motor may be drivably connected to the second propulsor. Each propulsor may thus be driven by the prime mover and/or the respective electric motor. The one or more electric motors may assist the prime mover by reducing ramp-up time of the prime mover and/or to increase the bollard pull above the power provided by the prime mover if required. The ramp-up time may be seen as the time it takes for the prime mover to increase or decrease its output. The one or more electric motors, such as the first electric motor and/or the second electric motor, may be connected to generator and/or a battery pack for providing power to the one or more electric motor(s). The generator may be configured to provide electricity directly to the one or more electric motor(s), and/or may be configured to charge the battery pack. In one or more example propulsion systems, the electric motors may be used as backup power sources for driving the propulsors in case the prime mover fails. The generator may be driven by the prime mover and/or may be driven by a separate combustion engine, such as a combustion engine separate from the prime mover, such as a combustion engine being smaller and/or more efficient than the prime mover.

The vessel may in one or more examples be a vessel used for firefighting, such as a vessel being equipped with a firefighting system. The firefighting system may comprise a combustion engine for driving a pump for providing a flow of water to a firefighting system.

In one or more examples, the separate combustion engine driving the generator may be the combustion engine driving the pump for providing the flow of water to a firefighting system of the vessel. In other words, the separate combustion engine may drive the generator and the pump for providing water to the firefighting system. In known vessels comprising a firefighting system, the engine driving the pump is typically separate from the propulsion system and is used solely for driving the pump. This ensures that the pumping capacity and the maneuverability of the vessel are not interfering with each other. By using the combustion engine driving the pump for providing water to the firefighting system for driving the generator, the engine driving the pump may be used as a backup power source and may provide propulsion power to the vessel in case of a failure of the prime mover. The generator may provide electricity to the one or more electric motor(s), and/or the battery pack, with less impact on the pumping capacity compared to the combustion engine directly driving the first and/or second propulsors. By using the combustion engine of the firefighting system as a backup to the prime mover, no additional combustion engine is required for providing backup propulsion power. This reduces the weight of the vessel which reduces the fuel economy of the vessel. The cost for the vessel may also be reduced, since one less combustion engine may be required. By combining an efficient prime mover, such as a marine diesel engine, such as a two-stroke crosshead diesel engine, with one or more electric motors, a propulsion system with very high efficiency may be achieved. The one or more electric motors may assist the prime mover in load ranges which are not optimal for the prime mover, and may thus improve the efficiency of the propulsion system compared to a propulsion system comprising only the prime mover. Thereby, the fuel consumption of the vessel may be reduced which reduces the operating cost and the environmental impact of the propulsion system.

The propulsion system may in some examples comprise a first gearbox and/or a second gearbox. The first gearbox may be arranged between the prime mover and the first propulsor. The second gearbox may be arranged between the prime mover and the second propulsor. The first gearbox and/or the second gearbox may be used to convert the output shaft revolutions of the prime mover to the revolutions required to rotate the first propulsor and/or the second propulsor. The first gearbox and/or second gearbox may transfer power from the output shaft of the prime mover to respective input shafts of the first propulsor and/or second propulsor and may reduce. The first gearbox and/or second gearbox may increase the speed of the respective input shafts of the first propulsor and/or the second propulsor compared to the output shaft of the prime mover.

In some example propulsion systems, the prime mover, the first propulsor and/or the second propulsor may be linearly arranged along a line extending through a rotation axis of the output shaft of the prime mover. The prime mover, the first propulsor and the second propulsor being linearly arranged may herein mean that an input shaft of the first propulsor and/or the second propulsor is concentrically arranged with an output shaft, such as the crankshaft shaft, of the prime mover. The propulsors, such as the first and/or the second propulsor, may be of the same size or of different sizes. The propulsors, such as the first and/or the second propulsor, may also be fixed or variable pitch. In some example propulsion systems, the first and the second propulsors may be directly driven by the prime mover. The respective input shafts of the first propulsor and/or the second propulsor may be concentrically arranged with the output shaft of the prime mover.

In some example propulsion systems, the propulsion system may further comprise a first and/or a second gearbox. The first and/or second gearbox may be arranged between the prime mover and the first and/or the second propulsor, respectively. The first and the second propulsor may be driven by the prime mover via the first gearbox and/or the second gearbox, respectively. The respective input shafts of the first gearbox and/or the second gearbox may be concentrically arranged with the output shaft of the prime mover. The respective input shafts of the first and/or the second propulsor may be concentrically arranged with the output shaft of the first gearbox and/or the second gearbox, respectively. In some example propulsion systems, the input shaft of the gearbox may, due to the gearing of the gearbox, be offset from the rotation axis of the output shaft of the gearing, such that a line extending through a rotation axis of the input shaft of the gearbox extends in parallel with the output shaft of the gearbox. The input shaft of the first propulsor and/or the second propulsor may thus be arranged in parallel with the output shaft, such as the crankshaft, of the prime mover.

In some example propulsion systems, the propulsion system may comprise more than two propulsors. The propulsion system may comprise the first and the second propulsor, and further comprise a third propulsor and/or a fourth propulsor, or even more propulsors. In some example propulsion systems, the first propulsor and the third propulsor may be connected to a first end of the output shaft of the prime mover. The second propulsor and the fourth propulsor may be connected to a second end of the output shaft of the prime mover. The second end of the output shaft may be opposite to the first end of the output shaft of the prime mover. The first propulsor and the third propulsor may be configured to be arranged at a fore end of the vessel. The second propulsor and the fourth propulsor may be configured to be arranged at an aft end of the vessel. The first propulsor and the third propulsor may be driven by the prime mover via the first gearbox. The second propulsor and the fourth propulsor may be driven by the prime mover via the second gearbox. The first gearbox may be configured to redirect the power provided from the prime mover to the first propulsor and/or the third propulsor. The second gearbox may be configured to redirect the power provided from the prime mover to the second propulsor and/or the fourth propulsor. The first gearbox and/or the second gearbox may comprise an, such as one, input shaft connected to the prime mover and one or more output shafts for connecting the gearbox to the first propulsor and the third propulsor, and/or to the second propulsor and the fourth propulsor, respectively. The one or more output shafts of the first and/or the second gearbox may be arranged at an angle, such as at an angle in the range of 0-90°, to the input shaft. The first gearbox and/or the second gearbox may e.g. comprise a bevel gear for redirecting the power to the propulsors at a desired angle to the input shaft.

In some example propulsion systems, the propulsion system may comprise additional propulsors, such as a fifth propulsor and/or a sixth propulsor. The further propulsors may be connected to the first gearbox and/or the second gearbox at a 0° angle to the input shaft of the first gearbox and/or the second gearbox at an opposite side of the gearbox than the input shaft of the gearbox. The first gearbox and/or the second gearbox may thus comprise three output shafts respectively. One output shaft may be arranged in parallel with the input shaft, and the other two output shafts may be arranged at an angle to the input shaft, such as perpendicular to the input shaft.

In some example propulsion systems, the propulsion system may comprise one or more clutches for connecting and/or disconnecting the prime mover from the plurality of propulsors, such as from the first propulsor and/or the second propulsor and/or the third propulsor, and/or the fourth propulsor, and/or the fifth propulsor, and/or the sixth propulsor. In some example propulsion systems, the propulsion system may comprise one or more clutches for connecting and/or disconnecting the prime mover and/or the plurality of propulsors from the first and/or the second gearbox.

A vessel is disclosed, comprising the propulsion system described above. In some example vessels, the prime mover, the first propulsor and/or the second propulsor of the propulsion system are arranged along a centerline of the vessel. In other words, the output shafts connecting the prime mover with the first propulsor and/or the second propulsor may be arranged along a centerline of the vessel, such as in parallel with a centerline of the vessel. In one or more examples, the centerline of the vessel is a longitudinal centerline extending midships from the fore of the vessel, such as from the fore peak of the vessel, to the aft of the vessel, such as to the aft peak of the vessel. The longitudinal centerline of the vessel may also be referred to as a longitudinal axis of the vessel. In some example vessels, the prime mover of the propulsion system and/or the first gearbox and/or the second gearbox may be arranged midships, such as longitudinally and/or laterally midships, of the vessel. In one or more examples, arranging the propulsion system along the centerline and/or midships of the vessel has the benefit that the weight distribution of the vessel may be improved, which may further increase the maneuverability of the vessel.

The first propulsor may be arranged at a fore section of the vessel and the second propulsor may be arranged at an aft section of the vessel, thereby increasing maneuverability of the vessel. In other words, the first propulsor and the second propulsors may be arranged along the longitudinal centerline of the vessel. In some examples, the vessel may be a tugboat.

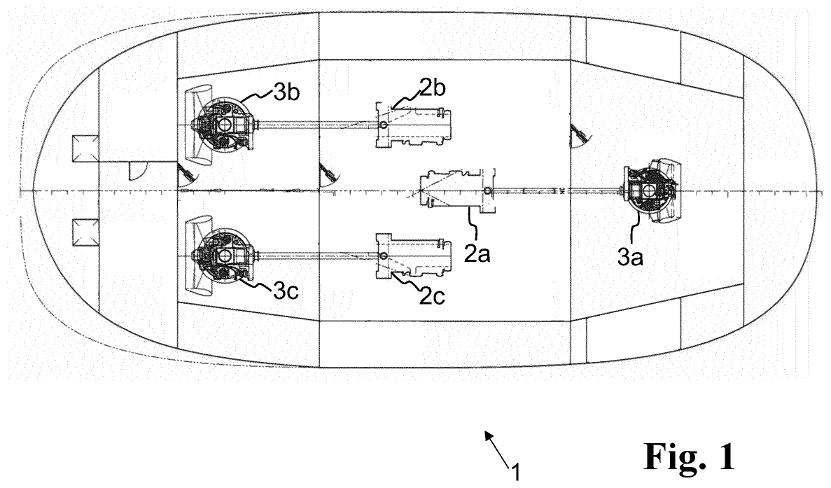

FIG. 1 illustrates a known propulsion system for a vessel, such as for a tugboat. In order to provide good maneuverability of the vessel, such as for the tugboat, known propulsion systems typically comprise a plurality of propulsors arranged at a fore and/or an aft end of the vessel. The known propulsion systems may e.g. comprise a first propulsor 3a, a second propulsor 3b and a third propulsor 3c. Each of the propulsors 3a; 3b; 3c is typically connected to a respective prime mover 2a; 2b; 2c. The prime movers 2a; 2b; 2c are typically high-speed four-stroke diesel engines having a rated speed of 1400 rpm or above, such as a high speed trunk piston type engines, since these have a barred speed range outside the typical speed range during operation of the vessel and fast load response. The barred speed range of the engine are engine speeds that create harmful torsional vibrations. Operation within the barred speed range is thus to be avoided. Vessels, such as tugboats, using the know propulsion systems are thus generally overpowered and inefficient, which reduces the fuel efficiency of the vessel. Further, maintenance costs are high since a plurality of prime movers need to be maintained. The high-speed engines typically also have shorter maintenance intervals and thus must be maintained more often, which increases down-time of the vessel and thus increases costs.

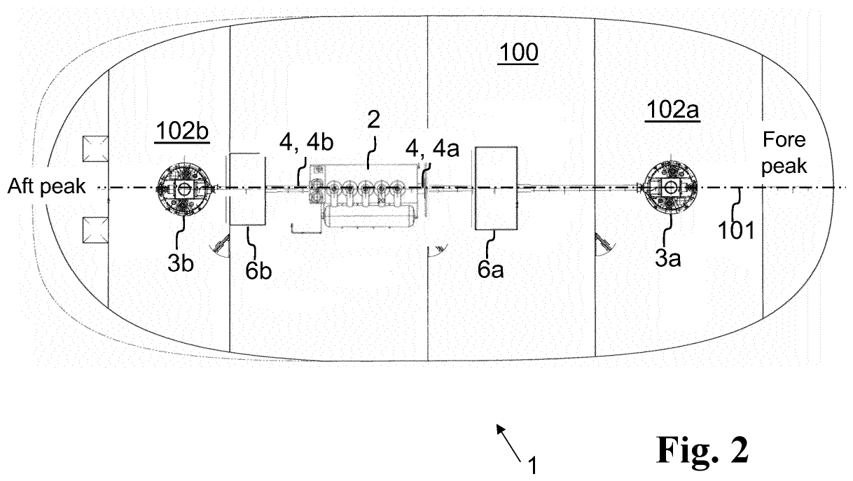

FIG. 2 illustrates an example propulsion system 1 for a vessel 100, such as for a tugboat. In the illustrated example shown in FIG. 2, the propulsion system is arranged on the vessel 100. The propulsion system 1 comprises a prime mover 2 for generating propulsion power, a first propulsor 3a and a second propulsor 3b. The first propulsor 3a and the second propulsor 3b are configured to convert the propulsion power generated by the prime mover 2 to thrust. The prime mover 2 comprises an output shaft 4 for driving the first propulsor 3a and the second propulsor 3b. The first propulsor 3a is drivably connected to a first end 4a of the output shaft 4. The second propulsor 3b is drivably connected to a second end 4b of the output shaft 4. The first propulsor 3a and the second propulsor 3b are thus connected to opposite ends of the same output shaft 4 of the engine. The first propulsor 3a may be configured to be arranged at a fore end 102a of the vessel 100. The second propulsor 3b may be configured to be arranged at an aft end of the vessel 100.

The prime mover 2 of the example propulsion system 1 shown in FIG. 2 may be an internal combustion engine. The output shaft 4 may be a crankshaft of the internal combustion engine. Inn some example propulsion systems, the internal combustion engine may be a diesel engine, such as a diesel engine being configured to operate at a rated power of 400 rpm or lower. The diesel engine may e.g. be a two-stroke crosshead diesel engine.

In some example propulsion systems, the first propulsor 3a and/or the second propulsor 3b may be propellers. In some example propulsion systems, the first propulsor 3a and/or the second propulsor 3b may be thrusters, such as azimuth thrusters.

In some example propulsion systems, the propulsion system 1 may comprise a first gearbox 6a and/or a second gearbox 6b, wherein the first gearbox 6a is arranged between the prime mover 2 and the first propulsor 3a and the second gearbox 6b is arranged between the prime mover 2 and the second propulsor 3b.

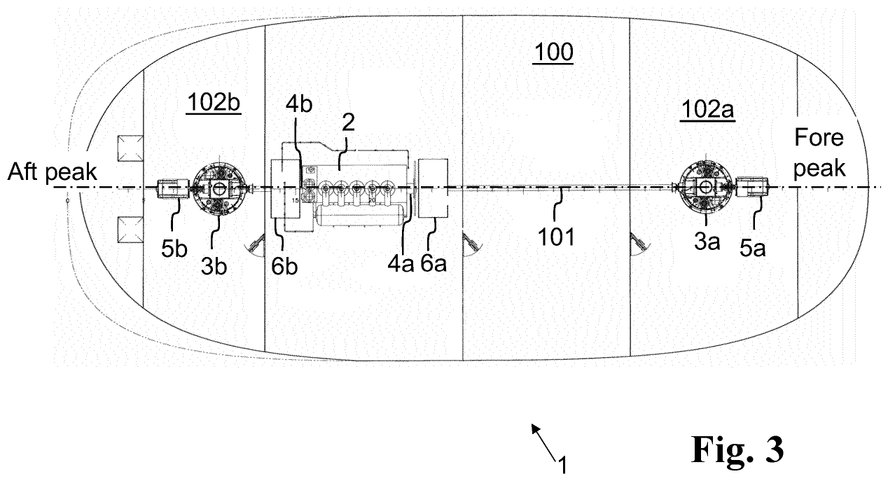

FIG. 3 illustrates an example propulsion system 1 for a vessel. The example propulsion system 1 of FIG. 3 is similar to the example propulsion system illustrated in FIG. 2 and further comprises one or more electric motors 5a, 5b drivably connected to the first propulsor 3a and/or the second propulsor 3b. The example propulsion system 1 of FIG. 3 comprises a first electric motor 5a and a second electric motor 5b. The first electric motor is drivably connected to the first propulsor 3a and the second electric motor 5b is drivably connected to the second propulsor 3b. The first propulsor 3a and/or the second propulsor 3b may thus be driven either by the prime mover 2 or by the one or more electric motors 5a, 5b, or simultaneously by the one or more electric motors 5a, 5b and the prime mover 2. The first propulsor 3a and/or the second propulsor 3b may be directly driven by the prime mover 2 or indirectly driven by the prime mover 2 via a respective gearbox 6a, 6b. The example propulsion system 1 of FIG. 3 may thus be a hybrid propulsions system 1, comprising the prime mover 2 and one or more electric motors 5a,

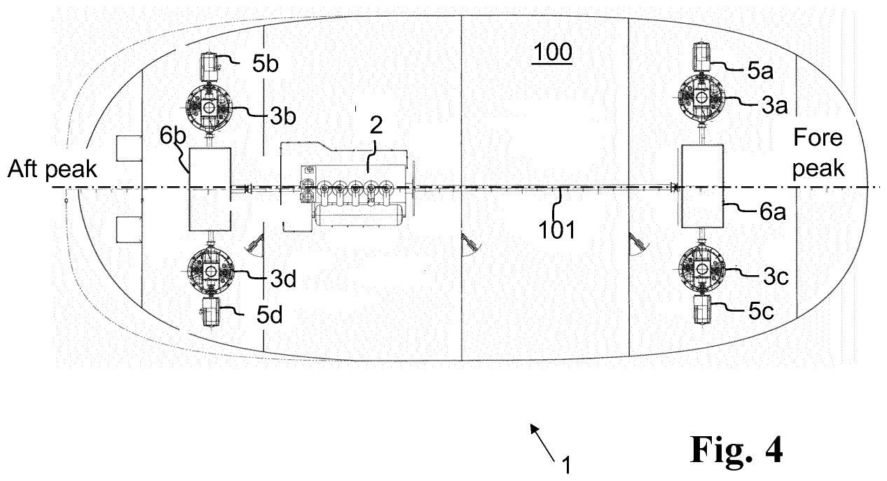

FIG. 4 illustrates an example propulsion system comprising the first and the second propulsor, and further comprising a third propulsor 3c and a fourth propulsor 3d. The first propulsor 3a and the third propulsor 3c may be connected to a first end of the output shaft 4 of the prime mover 2. The second propulsor 3b and the fourth propulsor 3d may be connected to a second end of the output shaft 4 of the prime mover 2, wherein the second end is opposite to the first end of the output shaft 4. The first propulsor 3a and the third propulsor 3c may be configured to be arranged at a fore end of the vessel. The second propulsor 3b and the fourth propulsor 3d may be configured to be arranged at an aft end of the vessel.

The first gearbox 6a and/or the second gearbox 6b may be configured to redirect the power provided from the prime mover 2 to the first propulsor 3a and the third propulsor 3c, and/or to the second propulsor 3b and the fourth propulsor 3d. The first gearbox 6a and/or the second gearbox 6b may comprise one input shaft connected to the prime mover 2 and one or more output shafts for connecting the gearbox to the first propulsor 3a and the third propulsor 3c, and/or to the second propulsor 3b and the fourth propulsors 3d. The one or more output shafts of the first and/or the second gearbox 6a, 6b, may be arranged at an angle to the input shaft of the first and/or the second gearbox 6a, 6b. In the example propulsion system 1 illustrated in FIG. 4, the one or more output shafts of the first gearbox 6a and the second gearbox 6b are arranged at a 90° angle to the input shaft. The first gearbox 6a and the second gearbox 6b may e.g. comprise a bevel gear for redirecting the power to the propulsors 6a, 6b, 6c, 6d.

The propulsion system 1 according to any one of the previous claims, wherein the prime mover 2, the first propulsor 3a and the second propulsor 3b of the propulsion system 1 are linearly arranged along a line extending through a rotation axis of the output shaft 4.

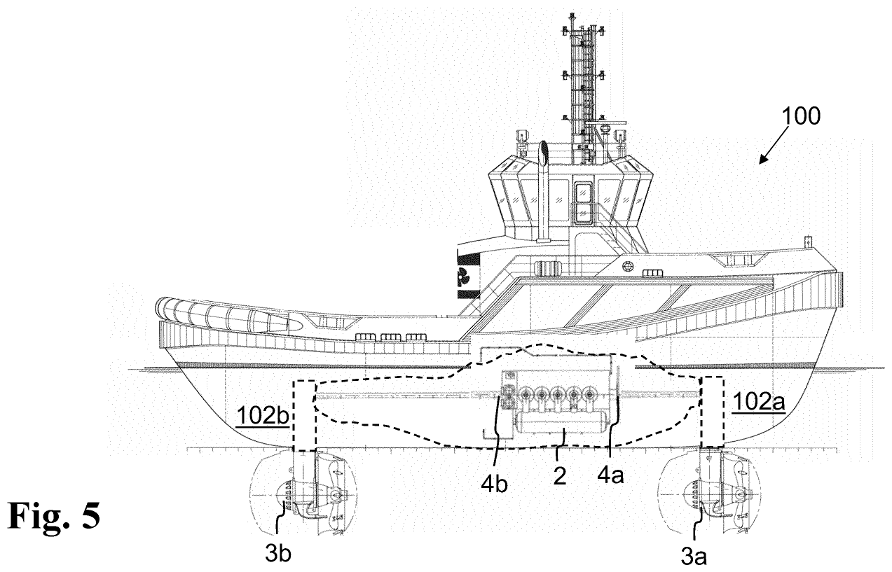

FIG. 5 illustrates an example vessel 100 comprising the propulsion system 1 according to the current disclosure. The propulsion system 1 of the vessel 100 comprises the prime mover 2, the first propulsor 3a and the second propulsor 3b for converting the propulsion power to thrust of the vessel. The prime mover 2 comprises an output shaft for driving the first propulsor 3a and the second propulsor 3b. The first propulsor 3a is drivably connected to a first end 4a of the output shaft and the second propulsor 3b is drivably connected to a second end 4b of the output shaft. The prime mover 2, the first propulsor 3a and the second propulsor 3b of the propulsion system 1 may be arranged along a centerline of the vessel 100. The first propulsor 3a may be arranged at a fore section 102a of the vessel 100 and the second propulsor may be arranged at an aft section 102b of the vessel 100. The vessel 100 according to the example illustrated in FIG. 5 is a tugboat.

It shall be noted that the features mentioned in the embodiments described in FIGS. 2-5 are not restricted to these specific embodiments. Any features relating to the propulsion system, such as the prime mover, the thrusters and/or the gearboxes and the components comprised therein and mentioned in relation to the propulsion system of FIGS. 2-3, are thus also applicable to the propulsion system and the vessel described in relation to FIGS. 4-5.

It shall further be noted that a vertical axis, when referred to herein, relates to an imaginary line running vertically through the ship and through its center of gravity, a transverse axis or lateral axis is an imaginary line running horizontally across the ship and through the center of gravity and a longitudinal axis is an imaginary line running horizontally through the length of the ship through its center of gravity and parallel to a waterline. Similarly, when referred to herein, a vertical plane relates to an imaginary plane running vertically through the width of the ship, a transverse plane or lateral plane is an imaginary plane running horizontally across the ship and a longitudinal plane is an imaginary plane running vertically through the length of the ship.

Embodiments of products (propulsion system and vessel) according to the disclosure are set out in the following items:
Item 1. A propulsion system (1) for a vessel, the propulsion system (1) comprising a prime mover (2) for generating propulsion power, a first propulsor (3a) and a second propulsor (3b) for converting the propulsion power to thrust, wherein the prime mover (2) comprises an output shaft (4) for driving the first propulsor (3a) and the second propulsor (3b), wherein the first propulsor (3a) is drivably connected to a first end (4a) of the output shaft (4) of the prime mover (2) and the second propulsor (3b) is drivably connected to a second end (4b) of the output shaft (4) of the prime mover (2).
Item 2. The propulsion system (1) according to Item 1, wherein the first propulsor (3a) and/or the second propulsor (3b) are propellers.
Item 3. The propulsion system (1) according to Item 1 or 2, and/or wherein the first propulsor (3a) and/or the second propulsor (3b) are thrusters.
Item 4. The propulsion system (1) according to any one of the previous Items, wherein the first propulsor (3a) and/or the second propulsor (3b) are Voith Schneider propellers
Item 5. The propulsion system (1) according to any one of the previous Items, wherein the propulsion system comprises one or more electric motors (5) drivably connected to the first propulsor and/or the second propulsor.
Item 6. The propulsion system (1) according to any one of the previous Items, wherein the propulsion system (1) comprises a first electric motor (5a) and a second electric motor (5b), wherein the first electric motor (5a) is drivably connected to the first propulsor (3a) and the second electric motor (5b) is drivably connected to the second propulsor (3b).
Item 7. The propulsion system (1) according to any one of the previous Items, wherein the propulsion system (1) comprises a first gearbox (6a) and a second gearbox (6b), wherein the first gearbox (6a) is arranged between the prime mover (2) and the first propulsor (3a) and the second gearbox (6b) is arranged between the prime mover (2) and the second propulsor (3b).
Item 8. The propulsion system (1) according to any one of the previous Items, wherein the prime mover (2) is an internal combustion engine.
Item 9. The propulsion system (1) according to Item 8, wherein the output shaft (4) is a crankshaft of the internal combustion engine.
Item 10. The propulsion system (1) according to Item 8 or 9, wherein the internal combustion engine is a diesel engine.
Item 11. The propulsion system (1) according to Item 10, wherein the diesel engine is configured to operate at a rated power of 400 rpm or lower.
Item 12. The propulsion system (1) according to Item 10 or 11, wherein the diesel engine is a two-stroke crosshead diesel engine.
Item 13. The propulsion system (1) according to any one of the previous Items, wherein the prime mover (2), the first propulsor (3a) and the second propulsor (3b) of the propulsion system (1) are linearly arranged along a line extending through a rotation axis of the output shaft (4).
Item 14. A vessel (100) comprising a propulsion system (1) according to any one of the previous Items.
Item 15. The vessel (100) according to Item 14, wherein the prime mover (2), the first propulsor (3a) and the second propulsor (3b) of the propulsion system (1) are arranged along a centerline (101) of the vessel.
Item 16. The vessel (100) according to Item 14 or 15, wherein the first propulsor (3a) is arranged at a fore section (102a) of the vessel (100) and the second propulsor is arranged at an aft section (102b) of the vessel (100).
Item 17. The vessel (100) according to any one of the Items 14 to 16, wherein the vessel (100) is a tugboat.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It is to be noted that the word “comprising” does not necessarily exclude the presence of other elements or steps than those listed.

It is to be noted that the words “a” or “an” preceding an element do not exclude the presence of a plurality of such elements.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

What is claimed is:

1. A propulsion system for a vessel, the propulsion system comprising:
a prime mover for generating propulsion power, a first propulsor and a second propulsor for converting the propulsion power to thrust, wherein the prime mover comprises an output shaft for driving the first propulsor and the second propulsor, wherein the first propulsor is drivably connected to a first end of the output shaft of the prime mover and the second propulsor is drivably connected to a second end of the output shaft of the prime mover, wherein the prime mover, the first propulsor and the second propulsor of the propulsion system are arranged along a centerline of the vessel and wherein the propulsor and the second propulsor are azimuth thrusters.

2. The propulsion system according to claim 1, wherein the propulsion system comprises one or more electric motors drivably connected to the first propulsor and/or the second propulsor.

3. The propulsion system according to claim 1, wherein the propulsion system comprises a first electric motor and a second electric motor, wherein the first electric motor is drivably connected to the first propulsor and the second electric motor is drivably connected to the second propulsor.

4. The propulsion system according to claim 1, wherein the propulsion system comprises a first gearbox and a second gearbox, wherein the first gearbox is arranged between the prime mover and the first propulsor and the second gearbox is arranged between the prime mover and the second propulsor.

5. The propulsion system according to claim 1, wherein the prime mover is an internal combustion engine.

6. The propulsion system according to claim wherein the output shaft is a crankshaft of the internal combustion engine.

7. The propulsion system according to claim 5, wherein the internal combustion engine is a diesel engine.

8. The propulsion system according to claim 7, wherein the diesel engine is configured to operate at a rated power of 400 rpm or lower.

9. The propulsion system according to claim 7, wherein the diesel engine is a two-stroke crosshead diesel engine.

10. The propulsion system according to claim 1, wherein the prime mover, the first propulsor and the second propulsor of the propulsion system are linearly arranged along a line extending through a rotation axis of the output shaft.

11. A vessel comprising a propulsion system according to claim 1.

12. The vessel according to claim 11,
wherein the first propulsor is arranged at a fore section of the vessel and the second propulsor is arranged at an aft section of the vessel.

13. The vessel according to claim 11, wherein the vessel is a tugboat.
